(19) United States
(12) Patent Application Publication
(10) Pub. No.: US 2026/0009504 A1
(43) Pub. Date: Jan. 8, 2026

(54) MOVABLE BODY COMPRISING HYDROGEN CONSUMING DEVICE

(71) Applicant: TOYOTA JIDOSHA KABUSHIKI KAISHA, Toyota-shi (JP)

(72) Inventor: Koji KATANO, Toyota-shi (JP)

(73) Assignee: TOYOTA JIDOSHA KABUSHIKI KAISHA, Toyota-shi (JP)

(21) Appl. No.: 19/257,404

(22) Filed: Jul. 1, 2025

(30) Foreign Application Priority Data
Jul. 2, 2024 (JP) 2024-106588

(51) Int. Cl. F17C 5/00

(52) U.S. Cl. CPC F17C 5/007; F17C 2221/012; F17C 2265/065

(57) ABSTRACT

A movable body may include: a hydrogen consuming device configured to consume hydrogen; at least one hydrogen tank configured to be filled with hydrogen; a filling port configured to receive hydrogen filled from outside the movable body; a filing pipe connecting the filling port and the hydrogen tank; a first supply pipe configured to supply hydrogen from the hydrogen tank to the hydrogen consuming device; a refill port configured to refill hydrogen to a refill destination outside the movable body; and a second supply pipe connecting the hydrogen tank and the refill port.

### REFERENCE TO RELATED APPLICATIONS

This application claims priority from Japanese Patent Application No. 2024-106588 filed on Jul. 2, 2024. The entire content of the priority application is incorporated herein by reference.

### TECHNICAL FIELD

The art disclosed herein relates to a movable body comprising a hydrogen consuming device.

### BACKGROUND

Japanese Patent Application Publication No. 2017-137926 describes a mobile hydrogen station. According to Japanese Patent Application Publication No. 2017-137926, a hydrogen gas filling device using a differential pressure filling method to supply hydrogen gas to a hydrogen gas using facility is mounted on a trailer. The trailer can be towed by a towing vehicle.

Japanese Patent Application Publication No. 2017-137926 only made the hydrogen gas filling device dedicated for supplying hydrogen gas to the hydrogen gas using facility, movable.

### SUMMARY

In response to this situation, there is a need for technologies for hydrogen refilling that are small-scale, inexpensive, simple, or involve at least one of these features to further promote use of hydrogen.

In an aspect of the art disclosed herein, a movable body may comprise: a hydrogen consuming device configured to consume hydrogen; at least one hydrogen tank configured to be filled with hydrogen; a filling port configured to receive hydrogen filled from outside the movable body; a filing pipe connecting the filling port and the hydrogen tank; a first supply pipe configured to supply hydrogen from the hydrogen tank to the hydrogen consuming device; a refill port configured to refill hydrogen to a refill destination outside the movable body; and a second supply pipe connecting the hydrogen tank and the refill port.

According to the above configuration, the movable body can refill hydrogen to an external refill destination from the at least one hydrogen tank that is configured to supply hydrogen to the hydrogen consuming device that the movable body itself carries. Thus, hydrogen refilling can be realized with a smaller, more inexpensive, and simpler configuration than conventional hydrogen stations or mobile hydrogen stations that only aim to supply hydrogen to an external destination.

### BRIEF DESCRIPTION OF DRAWINGS

FIG. 1 shows a schematic diagram of a part of a vehicle and its surroundings.

FIG. 2 shows a simplified view of a piping structure to a cap of a hydrogen tank.

FIG. 3 is a flowchart showing an example of a hydrogen refilling control process.

FIG. 4 is a flowchart showing an example of a safety assurance process.

FIG. 5 shows a simplified view of a nozzle and a nozzle holder and their surroundings.

FIG. 6 is a graph to illustrate effect of a configuration that preferentially selects a hydrogen tank with a low in-tank pressure.

FIG. 7 schematically illustrates an embodiment that includes a vehicle with a hydrogen cardle connected to its refill port.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved movable bodies, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

With reference to drawings, a present embodiment will be described. Each figure is only an example, and this embodiment is not limited to what is illustrated. Also, since each figure is an example, some of parts may be omitted.

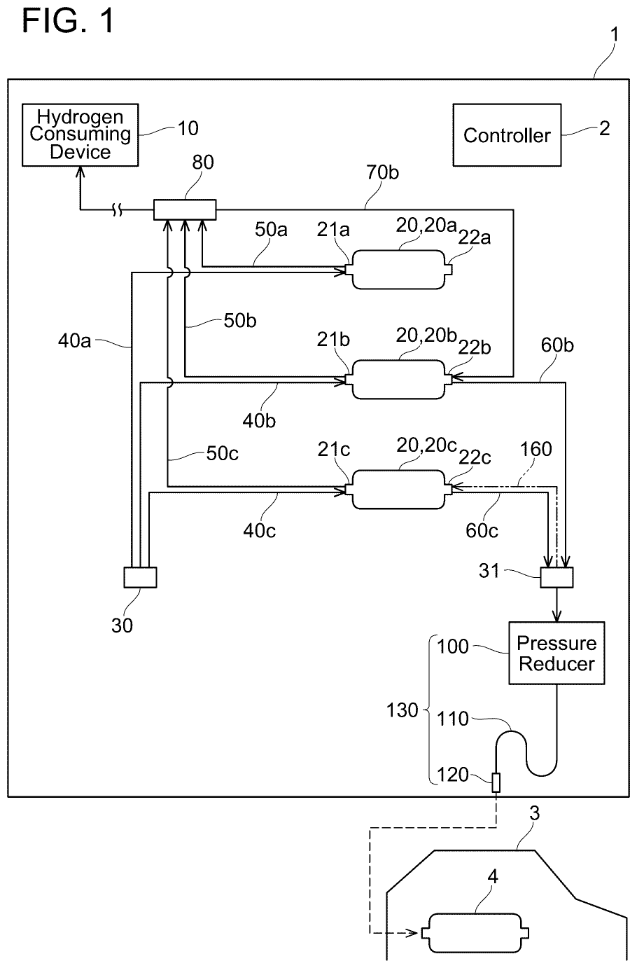

FIG. 1 shows a schematic representation of a part of a vehicle 1 and its surroundings of the vehicle 1. The vehicle 1 corresponds to an example of a movable body. However, in this specification, the movable body is not limited to a vehicle or other land-based movable body. A movable body may be, for example, a ship or a flying vehicle.

The vehicle 1 comprises a hydrogen consuming device 10 and at least one hydrogen tank 20 configured to be filled with hydrogen. The hydrogen consuming device 10 is, for example, a fuel cell or a hydrogen engine. Therefore, the vehicle 1 equipped with the hydrogen consuming device 10 can be considered as a vehicle that runs with the fuel cell or hydrogen engine as at least one of its power sources. The hydrogen consuming device 10 may also be a hydrogen combustor that uses hydrogen as fuel, such as a hydrogen burner. The vehicle 1 may be configured to have a plurality of hydrogen consuming devices 10 mounted therein.

The vehicle 1 comprises a filling port 30 configured to receive hydrogen filled from an external source and a refill port 31 configured to refill hydrogen to an external refill destination. In FIG. 1, a plurality of hydrogen tanks 20a, 20b, 20c is shown as hydrogen tanks 20. Each of the hydrogen tanks 20 is, for example, a cylindrical high-pressure hydrogen tank, and each of opposing ends has a cap. Hereinafter, the hydrogen tank 20 having one of the opposing ends connected to the refill port 31 with piping will be referred to as a “tank for refilling (refill tank)”. The hydrogen tank 20 which the vehicle 1 comprises and is not the refill tank will be referred to as a “normal tank”. In the example shown in FIG. 1, the hydrogen tank 20a corresponds to the “normal tank” and the hydrogen tanks 20b and 20c correspond to the “refill tank”. Needless to say, the fact that there are three hydrogen tanks is only one example. The number of normal tanks and the number of refill tanks are not limited. For example, there may be no normal tank. In this specification, the movable body comprises at least one refill tank.

The filling port 30 is connected to each of the hydrogen tanks 20 by filling pipes. According to FIG. 1, the filling port 30 is connected to the hydrogen tank 20a by a filling pipe 40a. Similarly, the filling port 30 is connected to the hydrogen tank 20b by a filling pipe 40b, and the filling port 30 is connected to the hydrogen tank 20c by a filling pipe 40c. Hydrogen gas is filled into each of the hydrogen tanks 20a, 20b, and 20c from an unillustrated external hydrogen station, for example, via the filling port 30 and the filling pipes 40a, 40b, and 40c.

In this specification, each pipe may be partially shared and/or branched in its middle to an extent that they can fulfill their respective functions. Sharing and/or branching of piping can be realized, for example, through a manifold.

Each hydrogen tank 20 is connected to a first supply pipe for supplying hydrogen to the hydrogen consuming device 10. According to FIG. 1, a first supply pipe 50a is connected to a first cap 21a of the hydrogen tank 20a. The filling pipe 40a is connected to the first cap 21a, too. Similarly, a first supply pipe 50b is connected to a first cap 21b of the hydrogen tank 20b to which the filling pipe 40b is connected, and a first supply pipe 50c is connected to a first cap 21c of the hydrogen tank 20c to which the filling pipe 40c is connected. Each of the hydrogen tanks 20a, 20b, 20c can supply hydrogen to the hydrogen consuming device 10 via the first supply pipe 50a, 50b, 50c.

The hydrogen tanks 20, which correspond to the refill tank, are connected to the refill port 31 by a second supply pipe. According to FIG. 1, a second cap 22b on the opposite side of the first cap 21b of the hydrogen tank 20b and the refill port 31 are connected by a second supply pipe 60b. Similarly, a second cap 22c on the opposite side of the first cap 21c of the hydrogen tank 20c and the refill port 31 are connected by a second supply pipe 60c. In other words, from the refill tank, hydrogen can be supplied to the hydrogen consuming device 10 of the vehicle 1 or to outside of the vehicle 1 via the refill port 31. A second cap 22a of the hydrogen tank 20a, which corresponds to the normal tank, is not in use and is closed.

As shown in FIG. 1, in the vehicle 1, a pressure reducer 100 is connected to the refill port 31. The pressure reducer 100 can depressurize the hydrogen supplied from the refill tank through the second supply pipe. The pressure reducer 100 includes, for example, a regulating valve (regulator) configured to reduce a pressure of fluid and a mass flow controller configured to measure a mass flow rate of the fluid and controls a flow rate. Furthermore, in the vehicle 1, an output side of the pressure reducer 100 comprises a hose 110 configured to refill hydrogen the pressure of which was reduced by the pressure reducer 100 to a refill destination and a nozzle 120 attached to an end of the hose 110. The hose 110 is flexible.

The nozzle 120 is connected to the refill destination which is outside the vehicle 1. The refill destination herein is a hydrogen tank owned by another movable body or facility that requires refilling of hydrogen. In the example in FIG. 1, the refill destination is a hydrogen tank 4 owned by a different vehicle 3 from the vehicle 1. The vehicle 3 is, for example, a vehicle equipped with a fuel cell or hydrogen engine, and the nozzle 120 is connected to an unshown filling port of the vehicle 3. As a result, hydrogen filled in the refill tank of the vehicle 1 is refilled to the hydrogen tank 4 of the vehicle 3.

The configuration including the pressure reducer 100, the hose 110, and the nozzle 120 can be viewed as a hydrogen refill module 130. In the vehicle 1, the hydrogen refill module 130 may be removable from the refill port 31. By making the hydrogen refill module 130 removable, for example, the hydrogen refill module 130 can be attached to the refill port 31 of the vehicle 1 to temporarily use the vehicle 1 as means of supplying hydrogen to outside.

As shown in FIG. 1, a transfer pipe 70b may be connected to the second cap 22b of the hydrogen tank 20b, which is a refill tank. In this specification, supplying hydrogen from one hydrogen tank 20 to another hydrogen tank 20 in the vehicle 1 will be referred to as “transfer”. The transfer pipe 70b connects from a manifold 80 leading to the hydrogen consuming device 10 to the second cap 22b of the hydrogen tank 20b. The manifold 80 is also connected to the first supply pipes 50a, 50b, 50c from the respective hydrogen tanks 20a, 20b, 20c. Thus, according to FIG. 1, the vehicle 1 can, for example, transfer hydrogen filled in the hydrogen tanks 20a and 20c to the hydrogen tank 20b via the first supply pipes 50a, 50c, the manifold 80, and the transfer pipe 70b.

Although not shown in the figure, for example, the manifold 80 and the second cap 22c of the hydrogen tank 20c may also be connected by a transfer pipe, so that hydrogen can be transferred to the hydrogen tank 20c from another hydrogen tank 20. In FIG. 1, the manifold 80 is simply described as a single manifold, but the manifold 80 may be separated into multiple manifolds. In other words, the manifolds to which each of the first supply pipes 50a, 50b, 50c is connected may be common one or separate ones. For example, by using multiple manifolds, the correspondences between the hydrogen tank 20 as the source of hydrogen transfer and the hydrogen tank 20 as the destination of hydrogen transfer may be more limited. In any case, the present specification may employ a configuration in which hydrogen is transferred from other hydrogen tank(s) 20 to at least one refill tank in the vehicle 1.

The vehicle 1 comprises a controller 2. The controller 2 comprises, for example, at least one of Electronic Control Unit(s) (ECU) installed in the vehicle 1. The controller 2 controls the vehicle 1 by executing program(s). The controller 2 corresponds to an example of a controller configured to control refilling of hydrogen to a refill destination by each of the hydrogen tanks 20.

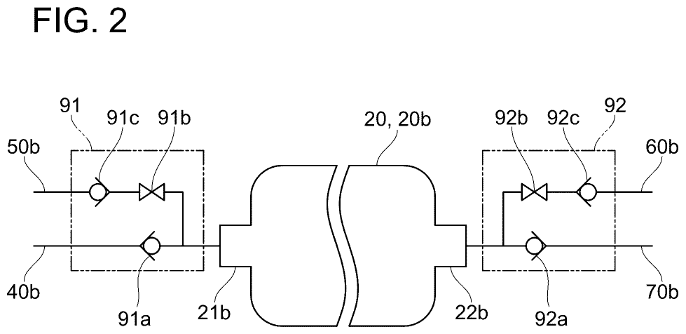

FIG. 2 shows a simplified example of a piping structure for each of the first cap 21b and the second cap 22b of the hydrogen tank 20b. The filling pipe 40b and the first supply pipe 50b are connected to the first cap 21b via a first piping structure 91. The second supply pipe 60b and the transfer pipe 70b are connected to the second cap 22b via a second piping structure 92.

According to FIG. 2, the first piping structure 91 comprises a check valve 91a to prevent backflow of hydrogen on a pipe connecting the filling pipe 40b and the first cap 21b. The first piping structure 91 also comprises a first gate valve 91b and a check valve 91c on a pipe connecting the first supply pipe 50b and the first cap 21b. The pipe connecting the filling pipe 40b to the first cap 21b and the pipe connecting the first supply pipe 50b to the first cap 21b merge at a position closer to the first cap 21b than these respective valves.

The second piping structure 92 comprises a check valve 92a on a pipe connecting the transfer pipe 70b and the second cap 22b, and a second gate valve 92b and a check valve 92c on a pipe connecting the second supply pipe 60b and the second cap 22b. The pipe connecting the transfer pipe 70b to the second cap 22b and the pipe connecting the second supply pipe 60b to the second cap 22b merge at a position closer to the second cap 22b than these respective valves.

Although not illustrated, it may be understood that the first piping structure 91 is similarly applicable to connection between corresponding filling pipes and the first supply pipes for each of the first caps 21a and 21c of the hydrogen tanks 20a and 20c. It may also be understood that at the second cap 22c of the hydrogen tank 20c, the second piping structure 92 is similarly applicable to connection with the second supply pipe 60c and possibly with the transfer pipe (or with a third supply pipe to be described below). FIG. 2 is only an example. The first piping structure 91 and/or the second piping structure 92 may comprise various valve(s), such as control valve(s) and/or pressure relief valve(s), as appropriate. Each of the first piping structure 91 and/or the second piping structure 92 may be configured such that flow paths opposite from a flow path connected to the cap of the hydrogen tank 20 are integrated into a single flow path, for example, in response to make the filling pipe and the first supply pipe partially merging into one and/or to make the transfer pipe and the second supply pipe partially merging into one.

The controller 2 opens and closes flow paths by individually controlling each gate valve of the first piping structure 91 and the second piping structure 92. Thus, for example, by individually controlling the first gate valve 91b and the second gate valve 92b with respect to one certain refill tank, the controller 2 can supply hydrogen from this refill tank to the hydrogen consuming device 10 via the first supply pipe or can refill hydrogen from this refill tank to an external refill destination via the second supply pipe.

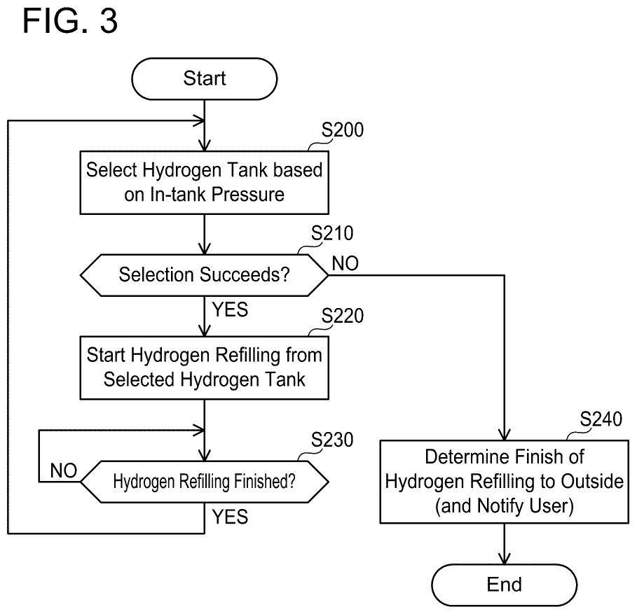

FIG. 3 shows a flowchart of an example of a hydrogen refilling control process performed by the controller 2. The controller 2 starts the hydrogen refilling control process on a condition that a “hydrogen refilling mode” is selected by a user of the vehicle 1. As a precondition for selecting the hydrogen refilling mode, the user connects the nozzle 120 to a desired external refill destination.

The user, for example, presses down an ignition switch of the vehicle 1 to put the vehicle 1 in an ignition-on state, and then performs a predetermined operation to select the hydrogen refilling mode. The vehicle 1 has, for example, a dedicated switch for selecting the hydrogen refilling mode, and the user selects the hydrogen refilling mode by operating said dedicated switch. The controller 2 recognizes that the hydrogen refilling mode has been selected and starts the hydrogen refilling control process. Only when the controller 2 recognizes that the hydrogen refilling mode has been selected, the controller 2 may start energizing directed to the second gate valve 92b and make the second gate valve 92b operable (valve openable).

In step S200, the controller 2 obtains an in-tank pressure of the refill tank(s), which is a pressure inside the hydrogen tank 20, and selects the hydrogen tank 20 to be used for refilling hydrogen to the refill destination based on the in-tank pressure. The controller 2 selects the refill tank whose in-tank pressure exceeds a predetermined threshold value. If there are multiple refill tanks in the vehicle 1, the controller 2 preferentially selects a refill tank with a lower in-tank pressure among the refill tanks whose in-tank pressures exceed the threshold value.

A method of acquiring the in-tank pressure of the refill tank is not limited in particular. The controller 2 can, for example, acquire the in-tank pressure by means of a pressure sensor installed in each of the hydrogen tanks 20. Alternatively, in step S200, the controller 2 may use the in-tank pressure of the refill tank that the controller 2 has stored prior to the time of step S200. The controller 2 may also open the first gate valve 91b corresponding to the refill tank individually and obtain the pressure measured by this valve opening as the in-tank pressure.

There are various methods of obtaining a threshold value for comparison with the in-tank pressure. The controller 2 may obtain the threshold value from a predetermined memory as a fixed value that is predetermined based on characteristics of the hydrogen tank 4 as the refill destination. The controller 2 may also obtain an appropriate value entered by a user's operation as the threshold value. Alternatively, the controller 2 may obtain the in-tank pressure of the hydrogen tank 4 through wired or wireless communication with the vehicle 3 and use a value obtained by adding a predetermined factor to the in-tank pressure of the hydrogen tank 4 as the threshold value.

In step S210, the controller 2 determines whether or not the hydrogen tank 20 has been successfully selected in step S200, and if the hydrogen tank 20 has been successfully selected, the controller 2 determines “YES” and proceeds to step S220. Contrary to this, if there is no hydrogen tank 20 that can be selected at that time, that is, if the hydrogen tank 20 has not been successfully selected, the controller 2 determines “NO” and proceeds to step S240. If, in step S200, all of the refill tanks of the vehicle 1 have an in-tank pressure below the threshold value, the controller 2 will proceed to step S240 from the “NO” decision in step S210, because there is no hydrogen tank 20 that can be selected.

In step S220, the controller 2 opens the second gate valve 92b corresponding to the hydrogen tank 20 selected in step S200 and starts refilling of hydrogen from said selected hydrogen tank 20 to the refill destination. As a result, refilling of hydrogen gas by differential pressure is performed. In step S220, if the first gate valve 91b corresponding to the hydrogen tank 20 selected in step S200 is open, the controller 2 closes this first gate valve 91b and then opens the second gate valve 92b corresponding to the hydrogen tank 20 selected in step S200. The controller 2 may also shut off the hydrogen supply to the hydrogen consuming device 10 from all the hydrogen tanks 20 of the vehicle 1, including the hydrogen tank 20 selected in step S200, when the hydrogen refilling to the refill destination is started in step S220.

In step S230, the controller 2 repeatedly determines whether or not the hydrogen refilling using the hydrogen tank 20 selected in step S200 as a refilling source has been completed. A method of determination in step S230 is not limited in particular. For example, the controller 2 may determine in step S230 that the hydrogen refilling has been completed, i.e., “YES”, when the in-tank pressure of the hydrogen tank 20 selected in step S200 reaches the threshold value used for the determination in step S200. Alternatively, the controller 2 may make the determination in step S230 based on a flow velocity of hydrogen gas at the opened second gate valve 92b. If the controller 2 determines that the hydrogen refilling using the hydrogen tank 20 selected in step S200 as the refilling source has been completed, the controller 2 proceeds to step S200 from “YES” in step S230. The controller 2 closes the second gate valve 92b corresponding to the hydrogen tank 20 from which the hydrogen refilling has been completed.

In the next step S200 proceeding from step S230, the controller 2 selects a next hydrogen tank 20 to be used for refilling hydrogen to the refill destination. According to this process flow, the controller 2 can switch the refill tanks to be used for refilling hydrogen to an external destination, for example, selecting the hydrogen tank 20b in the first step S200 after starting the hydrogen refilling control process, and selecting the hydrogen tank 20c for example in the second step S200, and so on.

In step S240, the controller 2 determines to end the hydrogen refilling to the external destination by the refill tank, and ends the hydrogen refilling control process. If “NO” is determined in the first step S210 after starting the hydrogen refilling control process, the controller 2 substantially prohibits hydrogen refilling by the refill tank to an external destination and finishes the hydrogen refilling control process. In step S240, the controller 2 may notify the user of the ending or prohibition of hydrogen refilling by the refill tank to an external destination. A method of this notification is not limited in particular. The controller 2 may provide said notification by an image and/or a sound using a display or speaker installed in the vehicle 1. Alternatively, the controller 2 may send said notification to a pre-designated external terminal or the like.

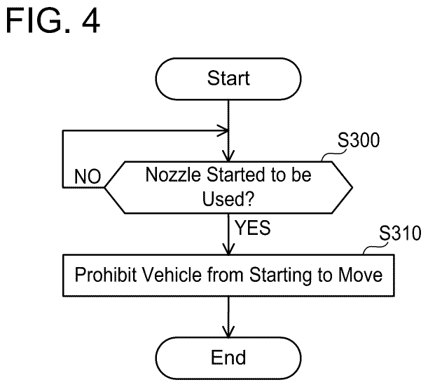

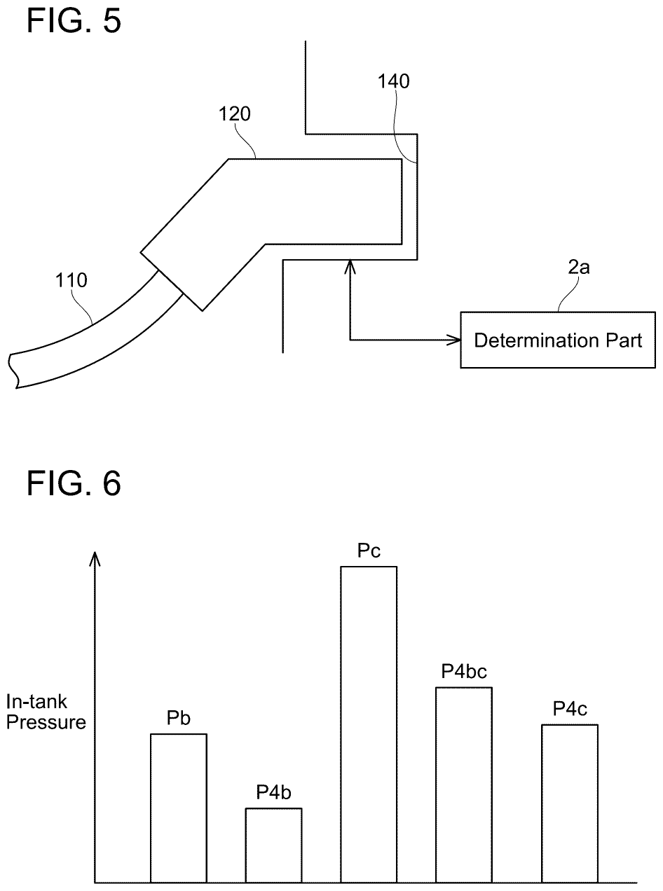

FIG. 4 shows a flowchart of an example of a safety assurance process performed by the controller 2. FIG. 5 also shows a simplified view of the nozzle 120 and a nozzle holder 140, and their surroundings. The nozzle 120 is held in the nozzle holder 140 when not in use. The vehicle 1 has the nozzle holder 140. Alternatively, the nozzle holder 140 may be viewed as a part of the hydrogen refill module 130 mounted in the vehicle 1. When the nozzle 120 is to be used, the user removes it from the nozzle holder 140 and connects it to an external refill destination as described above.

A determination part 2a recognizes whether the nozzle 120 is held by the nozzle holder 140 or not, for example, based on a response by an unshown sensor incorporated in the nozzle holder 140. The determination part 2a can be viewed as a part of the controller 2. The determination part 2a determines that the nozzle 120 is not in use during a period when the nozzle 120 is held in the nozzle holder 140, and when the determination part 2a recognizes that the nozzle 120 has been removed from the nozzle holder 140, the determination part 2a determines that the nozzle 120 is in use (step S300). When the determination part 2a determines that the nozzle 120 is now in use (“YES” in step S300), the controller 2 prohibits the vehicle 1 from starting to move (step S310). Prohibiting the vehicle 1 from starting to move means maintaining a speed of the vehicle at 0. The controller 2 maintains the prohibition of starting the vehicle 1 at least until the determination part 2a again determines that the nozzle 120 is not in use.

Thus, according to the present teachings, the movable body comprises: the hydrogen consuming device 10 configured to consume hydrogen; at least one hydrogen tank 20 configured to be filled with hydrogen; the filling port 30 configured to receive hydrogen filled from outside the movable body; the filing pipes connecting the filling port 30 and the hydrogen tank(s) 20; the first supply pipes configured to supply hydrogen from the hydrogen tank(s) 20 to the hydrogen consuming device 10; the refill port 31 configured to refill hydrogen to a refill destination outside the movable body; and the second supply pipes connecting the hydrogen tank(s) 20 and the refill port 31.

According to the above configuration, the movable body can refill hydrogen to the external refill destination from the at least one hydrogen tank 20 that is configured to supply hydrogen to the hydrogen consuming device 10 that the movable body itself carries. In other words, by adding the second supply pipes and the refill port 31 to the movable body such as, for example, the vehicle 1 comprising the hydrogen consuming device 10 and hydrogen tank(s) 20, the movable body can also be used as a means of refilling hydrogen to an external refill destination. Since this technology can be applied to, for example, a fuel cell vehicle or a hydrogen engine vehicle in which a user rides, hydrogen refilling can be realized with a smaller, more inexpensive, and simpler configuration compared to conventional mobile hydrogen stations.

According to the specification, the movable body may further comprise the pressure reducer 100 connected to the refill port 31 and configured to reduce the pressure of the hydrogen supplied from the hydrogen tank(s) 20 through the second supply pipes. According to the above configuration, hydrogen can be safely refilled to the refill destination by depressurizing the hydrogen as necessary with the pressure reducer 100. For example, the hydrogen tank 4 at the refill destination may need the hydrogen to be pre-cooled in anticipation of a temperature rise when the tank is filled with high-pressure hydrogen gas, but by depressurizing the hydrogen with the pressure reducer 100, the pressure of the hydrogen can be reduced to a level where such pre-cooling is not necessary.

According to the specification, the movable body may further comprise the hose 110 configured to refill hydrogen with the reduced pressure by the pressure reducer 100 to the refill destination; and the nozzle 120 attached to the end of the hose 110. According to the above configuration, the movable body comprises the hose 110 and the nozzle 120, so that hydrogen refilling from the hydrogen tank(s) 20 of the movable body to the refill destination can be performed more easily.

The nozzle 120 may be, for example, a nozzle of a standard that is compatible with the filling port 30. In other words, by making the standard of the nozzle 120 the same as the standard of nozzles used in existing hydrogen stations, etc., user convenience can be increased and effect of cost reduction can be generated.

According to the specification, the movable body comprises a plurality of hydrogen tanks 20, and the movable body further comprises the controller 2 configured to control refilling of hydrogen to the refill destination by each of the plurality of hydrogen tanks 20 (e.g., hydrogen tanks 20b, 20c). The controller 2 is configured to preferentially select the hydrogen tank 20 with a lower in-tank pressure among one or more of the hydrogen tanks 20 whose in-tank pressure exceed a predetermined threshold, and to refill hydrogen to the refill destination from the selected hydrogen tank 20.

If the refill tank with a higher in-tank pressure is selected first, the refill tank with a lower in-tank pressure cannot be subsequently used as the refilling source for the refill destination. Contrary to this, if the controller 2 selects the refill tank with a lower in-tank pressure first in step S200, the refill tank with a higher in-tank pressure can subsequently be used as the refilling source. As a result, hydrogen can be filled to a higher pressure to the hydrogen tank 4 being the refill destination.

FIG. 6 is a graph for illustrating exemplarily effect brought by the configuration of preferentially selecting the hydrogen tank 20 with a lower in-tank pressure. A vertical axis of the graph indicates the in-tank pressure, where Pb is an in-tank pressure in the hydrogen tank 20b before refilling hydrogen to the hydrogen tank 4 and Pc is an in-tank pressure in the hydrogen tank 20c before refilling hydrogen to the hydrogen tank 4, where Pb<Pc. P4b is an in-tank pressure in the hydrogen tank 4 after the hydrogen tank 20b is selected earlier than the hydrogen tank 20c in step S200 and hydrogen is refilled from the hydrogen tank 20b to the hydrogen tank 4. The in-tank pressure P4b is about half of the in-tank pressure Pb. P4bc is an in-tank pressure in the hydrogen tank 4 after the hydrogen tank 20c is selected after the hydrogen tank 20b in step S200 and hydrogen is refilled from the hydrogen tank 20c to the hydrogen tank 4. In this case, about a half of the difference between Pc and P4b is added to P4b to form the in-tank pressure P4bc.

P4c is an in-tank pressure in the hydrogen tank 4, assuming that the hydrogen tank 20c is selected earlier than the hydrogen tank 20b in step S200 and hydrogen is refilled from the hydrogen tank 20c to the hydrogen tank 4. The in-tank pressure P4c is about half of the in-tank pressure Pc. Since P4c>Pb, hydrogen cannot be further refilled from the hydrogen tank 20b to the hydrogen tank 4. Therefore, it can be said that the controller 2 can fill hydrogen to a higher pressure (e.g., by as much as the difference between P4bc and P4c shown in FIG. 6) to the refill destination by executing the flowchart in FIG. 3.

According to the specification, the movable body may further comprise the determination part 2a configured to determine whether or not the nozzle 120 has been started to be used or not. The movable body may be prohibited from starting to move when the determination part 2a determines that the nozzle 120 has been started to be used. According to the above configuration, it is possible to prevent the movable body from starting to move in a situation where the nozzle 120 is connected to an external refill destination, thus safety can be ensured.

The present teachings further disclose the following features.

When the controller 2 is to refill hydrogen from a refill tank to a refill destination, the controller 2 may receive information on the hydrogen tank 4 and a filling port of the refill destination from the vehicle 3 or a facility equipped with the hydrogen tank 4, and may, for example, control the pressure reducer 100 and refill hydrogen to the refill destination at a hydrogen flow rate or pressure boosting speed based on the received information. Communication for obtaining such information may be either wired or wireless. The information acquired in this manner is, for example, the in-tank pressure of the hydrogen tank 4 and/or a tank capacity of the hydrogen tank 4. Hydrogen refilling based on this information allows for safer execution of hydrogen refilling to an external destination.

The controller 2, for example, preferentially selects a normal tank as the hydrogen tank 20 to supply hydrogen to the hydrogen consuming device 10. When the normal tank becomes empty, the first gate valve corresponding to the refill tank may be opened to supply hydrogen from the refill tank to the hydrogen consuming device 10.

In the flowchart in FIG. 3, when the in-tank pressure of the refill tank is lower than the threshold value and therefore that refill tank cannot be selected, the controller 2 may transfer hydrogen to the refill tank from another hydrogen tank 20 that has a higher in-tank pressure than this refill tank. For example, if the controller 2 determines that the in-tank pressure of the hydrogen tank 20b is lower than the threshold value, the controller 2 may open the first gate valve corresponding to hydrogen tank 20c and transfer hydrogen from the hydrogen tank 20c to the hydrogen tank 20b via the first supply pipe 50c, the manifold 80, and the transfer pipe 70b. As a result, the in-tank pressure in the hydrogen tank 20b exceeds the threshold value and the hydrogen tank 20b can be selected for hydrogen refilling from the hydrogen tank 20b to the refill destination.

If the vehicle 1 comprises a plurality of refill tanks, the refill tanks may differ from each other in volume. For example, in FIG. 1, the volume of the hydrogen tank 20c is larger than the volume of the hydrogen tank 20b. In such a case, the controller 2 may control the hydrogen supply to the hydrogen consuming device 10 so that the in-tank pressure of the hydrogen tank 20 with a larger volume becomes higher. This makes it easier to preferentially select the hydrogen tank 20 with a smaller volume in step S200 in the hydrogen refilling control process in FIG. 3. Even if a hydrogen consumption rate is the same between the hydrogen tank 20 with a large volume and the hydrogen tank 20 with a small volume, the hydrogen tank 20 with a larger volume has a slower depressurization rate. Therefore, since the hydrogen tank 20 with a smaller volume has a faster depressurization rate and can easily increase its pressure by transferring from another hydrogen tank 20, hydrogen can be efficiently refilled by selecting the hydrogen tank 20 with a smaller volume as the refilling source for hydrogen refilling to an external destination.

Further, since a priority for selecting the hydrogen tank 20 with a larger volume in step S200 is lowered, the hydrogen tank 20 with a larger volume can be more easily used for supplying hydrogen to the hydrogen consuming device 10 in the vehicle 1. The hydrogen tank 20 with a larger volume has a slower depressurization rate during hydrogen consumption and a tank gas temperature is less likely to drop, allowing the vehicle to run at a higher power when the hydrogen consuming device 10 is in use.

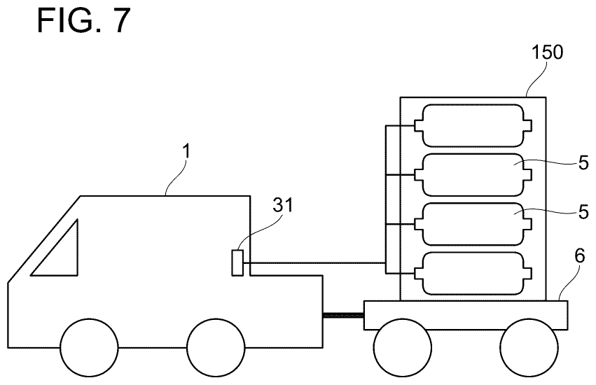

As shown in FIG. 7, a hydrogen cardle 150 may be temporarily connected to the refill port 31 of the vehicle 1, for example, instead of the pressure reducer 100 shown in FIG. 1. The hydrogen cardle 150 is a cardle that carries a plurality of hydrogen tanks 5 filled with hydrogen and enables the supply of hydrogen from these hydrogen tanks 5. In FIG. 7, the hydrogen cardle 150 may be mounted on a cart 6 configured to move with the vehicle 1, or may be mounted in the vehicle 1 itself. In a configuration that can employ the example of FIG. 7, the vehicle 1 comprises a third supply pipe for supplying hydrogen from the refill port 31 to the hydrogen tank(s) 20. As shown by a double-dotted line in FIG. 1, for example, a third supply pipe 160 may be provided connecting the refill port 31 and the second cap 22c of the hydrogen tank 20c. In other words, according to the example in FIG. 7, the vehicle 1 may also receive hydrogen refilling from each of the hydrogen tanks 5 of the hydrogen cardle 150 connected to the refill port 31 to its own hydrogen tank(s) 20 via the refill port 31 and the third supply pipe 160.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations, and are not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A movable body comprising:
a hydrogen consuming device configured to consume hydrogen;
at least one hydrogen tank configured to be filled with hydrogen;
a filling port configured to receive hydrogen filled from outside the movable body;
a filing pipe connecting the filling port and the hydrogen tank;
a first supply pipe configured to supply hydrogen from the hydrogen tank to the hydrogen consuming device;
a refill port configured to refill hydrogen to a refill destination outside the movable body; and
a second supply pipe connecting the hydrogen tank and the refill port.

2. The movable body according to claim 1, further comprising a pressure reducer connected to the refill port and configured to reduce a pressure of hydrogen supplied from the hydrogen tank through the second supply pipe.

3. The movable body according to claim 2, further comprising:
a hose configured to refill hydrogen with the reduced pressure by the pressure reducer to the refill destination; and
a nozzle attached to an end of the hose.

4. The movable body according to claim 1, wherein the hydrogen tank comprises a plurality of hydrogen tanks, and
the movable body further comprises a controller configured to control refilling of hydrogen to the refill destination by each of the plurality of hydrogen tanks,
wherein the controller is configured to preferentially select the hydrogen tank with a lower in-tank pressure, which is a pressure inside the hydrogen tank, among one or more of the hydrogen tanks whose in-tank pressure exceed a predetermined threshold, and to refill hydrogen to the refill destination from the selected hydrogen tank.

5. The movable body according to claim 3, further comprising a determination part configured to determine whether or not the nozzle has been started to be used or not,
wherein the movable body is prohibited from starting to move when the determination part determines that the nozzle has been started to be used.
